(19) United States
(12) Patent Application Publication
(10) Pub. No.: US 2020/0124153 A1
(43) Pub. Date: Apr. 23, 2020

(54) POWER TRANSMISSION DEVICE AND METHOD FOR OPERATING A POWER TRANSMISSION DEVICE IN A DRIVE TRAIN FOR DRIVING A WORKING MACHINE AT A VARIABLE SPEED

(71) Applicant: VOITH PATENT GMBH, HEIDENHEIM (DE)

(72) Inventor: HARTMUT GRAF, URBACH (DE)

(21) Appl. No.: 16/626,636

(22) PCT Filed: Jun. 13, 2018
(86) PCT No.: PCT/EP2018/065570

§ 371 Date: Dec. 26, 2019

(30) Foreign Application Priority Data
Jun. 26, 2017 (DE) 10 2017 114 063.8

(51) Int. Cl. F16H 47/08; F16H 3/66

(52) U.S. Cl. CPC F16H 47/085; B60T 1/087; F16H 3/66

(57) ABSTRACT

A power transmission device has a reverse torque converter and a planetary gear mechanism with a ring gear, sun wheel and planet carrier with several planets. An input is connected to an impeller of the reverse torque converter and to a first element of the planetary gear mechanism. A turbine wheel is connected to a second element of the planetary gear mechanism, and a third element of the planetary gear mechanism is connected to or forms an output of the power transmission device. A selectable control clutch transmits power in a first rotation speed range, with an emptied reverse torque converter, between the input and the output of the power transmission device. A device supports and/or fixes the second element of the planetary gear mechanism, in particular the connection between the turbine wheel and the second element of the planetary gear mechanism in this first rotation speed range.

The invention concerns a power transmission device, more specifically having the features of the preamble of claim 1.

Power transmission devices in drive trains for driving a working machine with variable rotation speed are known from the prior art in various designs. These are interposed between a drive machine, which can be operated with a constant rotation speed, and a working machine. For example, reference is made to Voith publication cr168de “Efficient control of pumps and compressors”; April 2013, and to WO2015071349 A1 and WO2012143123.

Such a power transmission device comprises at least one input which is or can be connected at least indirectly to the drive machine, an output which is or can be connected at least indirectly to the working machine, a hydrodynamic rotation speed/torque converter with at least one impeller, a turbine blade wheel and a guide wheel which form a working space that can be filled with operating medium, wherein at least one of the blade wheels comprises adjustable blades or adjustable blade segments, and a superposition gear mechanism. The superposition gear mechanism comprises at least one planetary gear mechanism with a ring gear, a sun wheel and a planet carrier with several planets, as elements of the planetary gear mechanism. The input of the power transmission device is connected at least indirectly, preferably directly, to the impeller of the hydrodynamic converter and to a first element of the planetary gear mechanism. The turbine wheel of the hydrodynamic converter is connected at least indirectly, preferably directly, to a second element of the planetary gear mechanism, and a third element of the planetary gear mechanism is at least indirectly connected to or forms the output. The power is transmitted by power division over a hydrodynamic branch and a mechanical power branch, wherein the power portions are combined in the planetary gear mechanism. An operating medium supply and/or conduction system is assigned at least to the converter, preferably to the power transmission device, and a device is provided for filling and/or emptying the converter. The converter is filled during operation.

A generic power transmission device in compact design, with the converter formed as a reverse torque converter and a planetary gear mechanism, is previously known from WO2012143123 and WO2015071349 A1. To control the transmission behavior of the converter, this is configured as an adjustable converter with adjustable blades on the guide wheel or impeller. With this measure, the transmission behavior can be controlled over a predefined rotation speed range. However, the rotation speed range which can be covered thereby is very small. If furthermore such a drive concept is used for driving working machines with high power demand, start-up takes place under very high load due to the inertia of the working machine. This requires very high necessary starting currents of the electrical drive machine, which result in great network fluctuations and require a corresponding design thereof.

The invention is therefore based on the object of refining a power transmission device for driving a working machine with variable rotation speed, and a method for its operation, so as to avoid the disadvantage of high necessary starting currents on use of electric drive machines, or high necessary start-up moments.

The solution according to the invention is characterized by the features of claim 1. Advantageous embodiments are described in the subclaims.

A power transmission device with an input for connection to a drive machine which can be operated at a constant rotation speed, and at least one output for connection to a working machine which can be driven at a variable rotation speed, comprises:
a hydrodynamic rotation speed/torque converter configured as a reverse torque converter with at least one impeller, a turbine blade wheel and a guide wheel which form a working space that can be filled with operating medium;
a superposition gear mechanism with at least one planetary gear mechanism having a ring gear, a sun wheel and a planet carrier with several planets, as elements of the planetary gear mechanism, wherein the input of the power transmission device is at least indirectly, preferably directly, connected to the impeller of the reverse torque converter and to a first element of the planetary gear mechanism, the turbine wheel of the reverse torque converter is at least indirectly connected to a second element of the planetary gear mechanism, and a third element of the planetary gear mechanism is at least indirectly connected to or forms the output of the power transmission device.

The power transmission device according to the invention is characterized in that the reverse torque converter can be emptied. Furthermore, a selectable control clutch is provided for transmitting the power in a first rotation speed range, with an emptied reverse torque converter, between the input and the output of the power transmission device, and a device for at least indirectly supporting and/or fixing the second element of the planetary gear mechanism, in particular the connection between the turbine wheel of the reverse torque converter and the second element of the planetary gear mechanism in this first rotation speed range. The reverse torque converter is active in a second rotation speed range.

According to the invention, to improve the start-up behavior and to avoid high run-up currents of the drive machine, a selectable control clutch is provided in the power transmission device and serves for power transmission at least over a partial range of the operating range outside the control range of the reverse torque converter. This takes place in a first rotation speed range, in particular during start-up of the drive machine, and performs the power transmission between the input and the output of the power transmission in this speed range. The control clutch allows gentle and stepless adjustment of the torque transmission during start-up of the drive machine, whereby a load-free run-up is possible. Thus rotation speeds at the output of the power transmission device can be set within a rotation speed range which cannot be achieved with the control range of the reverse torque converter or can only be achieved with significant modifications to this.

“Selectable” in the sense of the invention means that the control clutch has at least two operating states—activated and deactivated.

The term “control clutch” implies the capacity of the clutch to act as a torque converter, and set in targeted fashion the rotation speed at the clutch output and hence at the output of the power transmission device which is at least indirectly connected thereto. For this, the control clutch comprises at least two clutch parts which can be brought at least indirectly into active engagement with each other.

In order to achieve a unit with dimensions as compact as possible and with minimal number of components, preferably the reverse torque converter, the superposition gear mechanism and the selectable control clutch are arranged coaxially to each other. In a particularly advantageous refinement, the input, output and reverse torque converter, the superposition gear mechanism and selectable control clutch, are arranged coaxially to each other.

With regard to the arrangement of the control clutch, there is a multiplicity of possibilities. Preferably, in the basic configuration, the reverse torque converter and the superposition gear mechanism, viewed in the axial direction from the input to the output of the power transmission device, are arranged directly adjacent to each other, i.e. without any interposition of the control clutch. According to a first embodiment, the latter may be arranged on the input side, i.e. upstream of the basic configuration of reverse torque converter and superposition gear mechanism, in other words on the side of the reverse torque converter facing away from the superposition gear mechanism; or, according to a second particularly advantageous embodiment, downstream of the basic configuration of reverse torque converter and superposition gear mechanism, and hence on the side of the superposition gear mechanism facing away from the reverse torque converter.

In the first embodiment, the impeller of the reverse torque converter and the output part of the control clutch are directly connected together, in particular arranged on one shaft, wherein a direct drive device is assigned to the control clutch in order to bridge this and create the connection between the input and the impeller of the reverse torque converter. This first embodiment offers the advantage that on the output side, either a direct coupling can take place between the output and the superposition gear mechanism, or arbitrary further rotation speed/torque conversion devices may be arranged without restrictions between the superposition gear mechanism and the output.

In the second embodiment, the input part of the control clutch is connected to the third element of the planetary gear mechanism or superposition gear mechanism. A direct drive device is assigned to the control clutch in order to bridge this and create the connection between the third element of the superposition gear mechanism and the output. The particular advantage of this second embodiment is that the input part of the control clutch, because of its coupling to the output of the superposition gear mechanism, in particular the planetary gear mechanism, is already driven with a higher rotation speed, and the control clutch may therefore be dimensioned substantially smaller with regard to transferable moments, which results in lower costs as well as a saving in installation space.

In a refinement of the second embodiment, the output part of the control clutch is connected either directly or via a rotation speed/torque conversion device, in particular a spur gear train, to the output of the power transmission device. In this way, it is possible to introduce additional step-up or step-down ratios in the power transmission device. Furthermore, a standardized basic configuration of reverse torque converter and superposition gear mechanism may be used, which may then be adapted to the actual application requirements by means of the additional rotation speed/torque conversion device.

In both embodiments, in general the input and output may be arranged coaxially or eccentrically relative to each other.

With regard to the configuration of the direct drive device, there is a multiplicity of possibilities. Preferably, mechanical devices in the form of selectable clutches are used. According to a particularly advantageous embodiment, the direct drive device is also formed by the control clutch in a concentration of function. This is conceivable in particular in the case of mechanical control clutches as controllable multiplate clutches.

The direct drive device may however also be configured and arranged as a separate clutch device, as a bridging clutch.

In an advantageous embodiment with minimal wear, the control clutch is configured as a controllable hydrodynamic clutch, in particular a hydrodynamic clutch with fill control. Filling may be easily controlled in a targeted fashion, for example via valve devices in the supply to and/or discharge from the working space, or via so-called scoop tubes.

In order to be able to drive the third element of the planetary gear mechanism, a device is provided for supporting and/or fixing the second element of the planetary gear mechanism, in particular the connection between the turbine wheel of the reverse torque converter and the superposition gear mechanism. This device is preferably configured as a braking device, in particular a hydrodynamic retarder, wherein the rotor is directly connected to the turbine wheel of the reverse torque converter or to the connection between the turbine wheel and the second element of the planetary gear mechanism. The stator may be connected to either a component fixed relative to the housing, or to the first element of the planetary gear mechanism. Here, the embodiment as a hydrodynamic retarder has the advantage that the support force can be freely set.

In an alternative embodiment of the device, the latter is designed as a clutch device comprising at least two clutch parts which can be brought at least indirectly into active connection with each other. A first clutch part is connected directly to the turbine wheel of the reverse torque converter or to the connection between the turbine wheel and the second element of the planetary gear mechanism, and the second clutch part is connected to a component fixed relative to the housing, or to the first element of the planetary gear mechanism.

In order to provide a particularly compact power transmission device, the superposition gear mechanism comprises only a planetary gear mechanism. The first element of the planetary gear mechanism is formed by the carrier, the second element of the planetary gear mechanism is formed by the sun wheel, and the third element of the planetary gear mechanism is formed by the ring gear.

In order to freely control the transmission behavior, the reverse torque converter is configured as an adjustable converter comprising adjustable blades or adjustable blade segments on at least one of the blade wheels—impeller, turbine wheel and/or guide wheel.

The invention furthermore concerns a drive train with a drive machine which can be driven with a constant rotation speed, and with a power transmission device as claimed in any of claims 1 to 12 for driving a working machine with variable rotation speed. The rotation speed of the working machine can be freely set over a large rotation speed range.

The method according to the invention for operating a power transmission device as claimed in any of claims 1 to 12 is characterized by the following method steps:
running up the drive machine from a standstill with an empty hydrodynamic rotation speed/torque converter until reaching a predefined value at least indirectly characterizing the operating mode of the drive machine, in particular its nominal rotation speed,
at the same time as reaching the predefined value at least indirectly characterizing the operating mode of the drive machine, in particular the nominal rotation speed, or with a temporal offset after reaching this, engaging or activating the control clutch, in particular the hydrodynamic clutch, and supporting or fixing the second element, in particular the sun wheel of the planetary gear mechanism of the superposition gear mechanism,
controlling the transmission behavior of the control clutch over a predefined first rotation speed range,
when reaching the end of the predefined rotation speed range, bridging the control clutch and deactivating the device for support and/or fixing, and filling the hydrodynamic rotation speed/torque converter, and driving the turbine wheel,
driving the third element of the planetary gear mechanism with a rotation speed which results from a superposition, defined by the planetary gear mechanism, of the rotation speed of the first element of the planetary gear mechanism connected to the drive machine, and the rotation speed of the second element of the planetary gear mechanism at least indirectly connected to the turbine wheel,
controlling the transmission behavior of the reverse torque converter.

The solution according to the invention is explained below with reference to figures. The drawings show the following in detail:

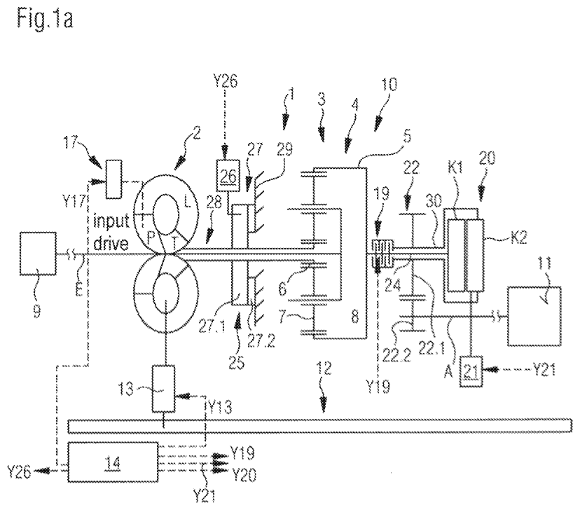

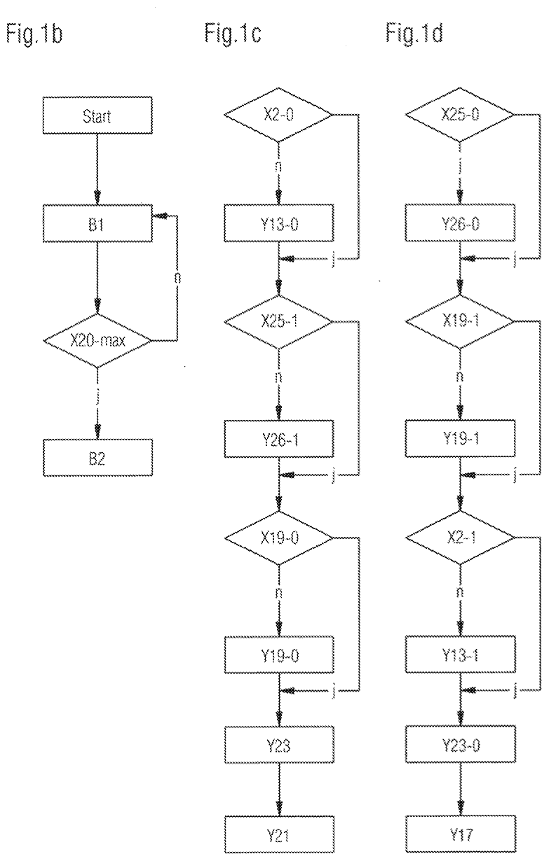

FIG. 1a a first embodiment of a power transmission device;

FIGS. 1b to 1d using flow diagrams, a method for operating a power transmission device according to FIG. 1a;

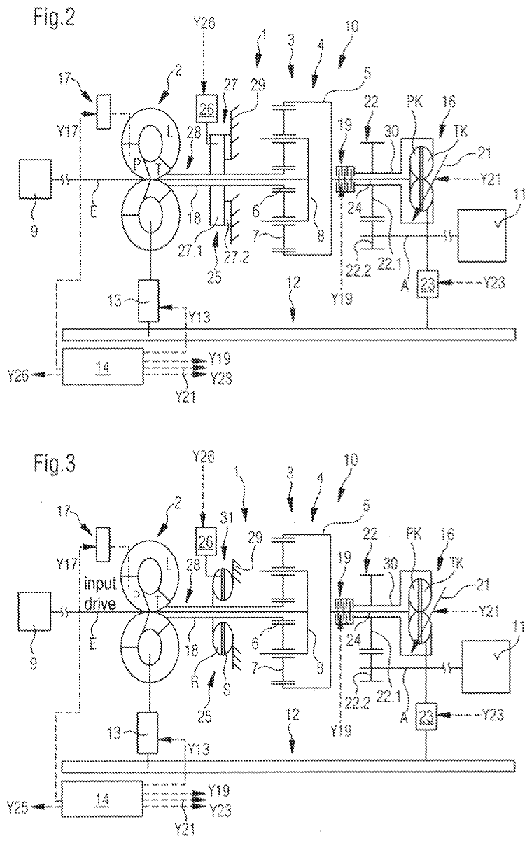

FIG. 2 an embodiment according to FIG. 1a with the control clutch configured as a hydrodynamic clutch;

FIG. 3 an embodiment according to FIG. 1a with the control clutch configured as a hydrodynamic clutch, and the device for supporting and/or fixing configured as a hydrodynamic retarder;

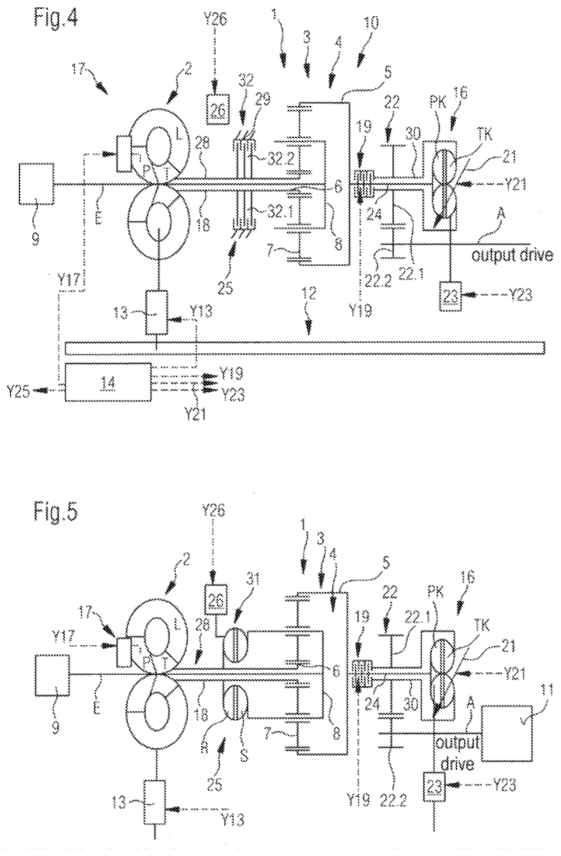

FIG. 4 an embodiment according to FIG. 1a with the control clutch configured as a hydrodynamic clutch, and the device for supporting and/or fixing configured as a clutch device;

FIG. 5 an embodiment according to FIG. 3 with the stator of the hydrodynamic retarder coupled to an element of the planetary gear mechanism;

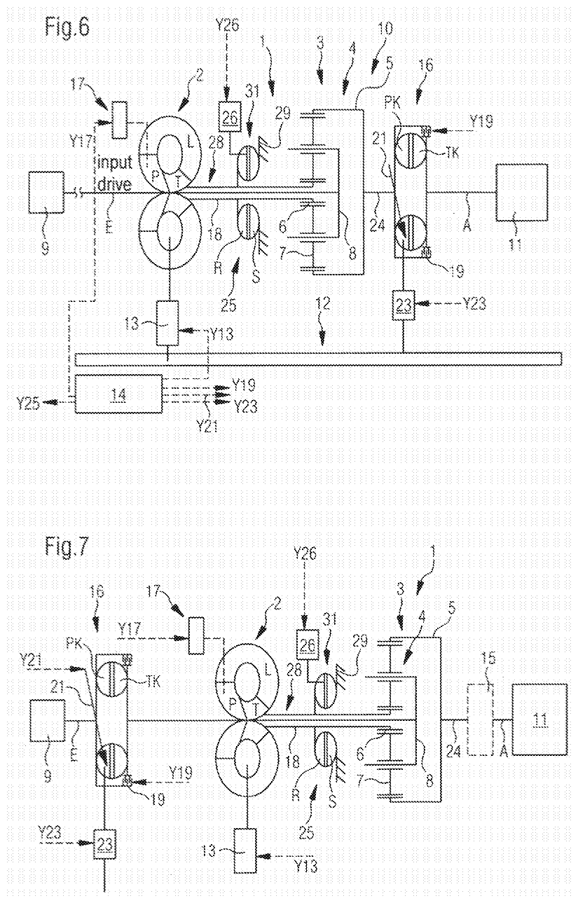

FIG. 6 an embodiment according to FIG. 3 with the input and output arranged coaxially;

FIG. 7 an alternative arrangement of the control clutch on the side of the reverse torque converter facing away from the superposition gear mechanism.

The power transmission devices 1 depicted in the following figures all comprise an input E, an output A, a reverse torque converter 2, a superposition gear mechanism 3, a control clutch 20 and a device 25 for supporting and/or fixing the second element of the planetary gear mechanism 4, in particular the connection between the reverse torque converter 2 and the superposition gear mechanism 3.

FIG. 1a illustrates, in a simplified diagrammatic depiction, the basic structure of a power transmission device 1 configured according to the invention, in a first embodiment with eccentric arrangement of input E and output A. FIGS. 1b to 1d illustrate, using flow diagrams, as an example an advantageous method for operating such a power transmission device 1. The possibility exists here of further modifying the temporal sequence of activation of the individual components, or mutually matching this differently. The common feature however is the power transmission by the control clutch 20 in a first rotation speed range, and by the reverse torque converter 2 only in a second rotation speed range.

The power transmission device 1 is depicted as an example in a drive train 10 for driving a working machine 11, in particular with variable rotation speed, by means of a drive machine 9, in particular a drive machine with constant rotation speed. The power transmission device 1 is arranged in the force flow between the drive machine 9 and the working machine 11. FIG. 1a shows as an example a basic design which may be further modified with regard to the coupling between the individual components and by the integration of further, additional devices.

The power transmission device 1 comprises at least one input E which is connected at least indirectly to the drive machine 9, and an output A which is or can be connected at least indirectly to the working machine 11, a hydrodynamic rotation speed/torque converter configured as a reverse torque converter 2, and a superposition gear mechanism 3 comprising at least one planetary gear mechanism 4. The input E and output A are preferably configured as input and output shafts. It is also conceivable to configure these in the form of torque-transmitting function components. The phrase “is or can be connected at least indirectly” means connected either directly or via further intermediate components, which may include also devices for rotation speed/torque conversion, for example spur gear stages or further planetary gear stages.

The superposition gear mechanism 3 comprises at least one—in the particularly advantageous and compact embodiment depicted, precisely one—planetary gear mechanism 4 with at least a ring gear 5, a sun wheel 6 and a carrier 8 carrying the planet wheels 7, as elements of the planetary gear mechanism 4. The planet wheels 7 are mounted rotatably on the carrier 8.

The hydrodynamic reverse torque converter 2 comprises at least one impeller P, a turbine wheel T and a guide wheel L. The input E is connected at least indirectly, preferably directly, to the impeller P and to a first element of the planetary gear mechanism 4; the turbine wheel T is connected at least indirectly, preferably directly, to a second element of the planetary gear mechanism 4; and the output A is connected at least indirectly, preferably directly, to a third element of the planetary gear mechanism 4.

The connection to the planetary gear mechanism 4 here takes place such that the impeller P of the hydrodynamic reverse torque converter 2 is coupled to the carrier 8 of the planetary gear mechanism 4 and to the input E, while the turbine wheel T is coupled at least indirectly, preferably directly, to the sun wheel 6 of the planetary gear mechanism. The input E or the shaft forming or coupled to this, in a particularly advantageous embodiment, is guided by a connecting shaft which is configured as a hollow shaft 18 and forms the connection 28 between the turbine wheel T and the second element of the planetary gear mechanism 4 (here the sun wheel 6) between the turbine wheel T and.

The reverse torque converter 2 may be configured as a single-stage or multistage converter, furthermore as a single-phase or multiphase converter.

An operating medium supply and/or conduction system 12 is assigned to the reverse torque converter 2. This may be an operating medium supply and/or conduction system assigned solely to the converter, or a system assigned to several components of the power transmission device 1, or a system assigned to the power transmission device 1 or to a higher-level unit. Preferably, at least one actuating device 13 is assigned to this for filling and/or emptying.

The reverse torque converter 2 is characterized in that the impeller P and the turbine wheel T run in opposite directions. The turbine wheel T may be arranged next to the impeller P in the axial direction. Embodiments with radial arrangement are also conceivable. Furthermore, the reverse torque converter 2 comprises at least one guide wheel L. The guide wheel L is preferably stationary (single-phase converter) but may also be mounted rotatably or be supported via a freewheel device (multiphase converter). In the case depicted, the converter is configured with one-piece main elements—impeller P, turbine wheel T or guide wheel L—and with a single stage. The reverse torque converter 2 may also be configured in multiple parts, wherein then at least one main element—impeller P, turbine wheel T or guide wheel L—consists of several blade rings. Multipiece converters may furthermore be configured with a single or multiple stages. In the latter case, at least one of the main elements—impeller P, turbine wheel T or guide wheel L—consists of several blade rings, between which in the circuit another main element—impeller P, turbine wheel T or guide wheel L—is arranged.

To control and/or regulate the moment and/or rotation speed which can be transmitted via the reverse torque converter 2, the reverse torque converter 2 is configured as an adjustable converter. This function may be implemented in various ways. It is conceivable to implement this by so-called annular sliders, adjustable blades, in particular twist blades or blade segments, or devices for adjusting the fill level, in particular filling and emptying valves.

In an advantageous embodiment, the reverse torque converter 2 is designed with adjustable blades or blade segments on at least one of the blade wheels—impeller P, turbine wheel T or guide wheel L—in order to influence and control the transmission behavior, in particular the power transmission behavior and rotation speed. Quite particularly preferably, the reverse torque converter 2 is configured with adjustable blades or blade segments on the impeller P, as depicted in exemplary fashion in FIGS. 1a to 7. The actuator device for influencing the transmission behavior is designated 17. The corresponding actuating signals Y13 to Y17 are emitted by a control device 14. It is understood that the depicted possibilities for adjustment of the blade components are exemplary, and other blade wheels, in particular the guide wheel L, may additionally or alternatively be equipped with adjustable blades.

In an alternative embodiment, the function of the actuating device 17 for influencing the transmission behavior may also be performed, in concentration of function, by an actuating device 13 for filling and emptying. In this case, the supply to and discharge from the working space is controlled accordingly.

Via the device 17 for influencing the transmission behavior, it is possible to control the reverse torque converter 2 in an operating range, known as the converter mode, according to the rotation speed and torque. In converter mode, part of the power is transmitted mechanically from the input E via the superposition gear mechanism 3, and a further part hydrodynamically via the reverse torque converter 2, wherein the power proportions are combined again in the superposition gear mechanism 3. In relation to a total operating range of the power transmission device 1, the possible rotation speed control range of the reverse torque converter 2 is limited. In order to expand the rotation speed control range of the power transmission device 1, according to the invention therefore a selectable, adjustable clutch is provided, in particular the control clutch 20. In a similar fashion to the converter, the control clutch 20 serves for transmitting the moment from input E to output A in a first power branch over a first rotation speed range, while the reverse torque converter 2 serves for power transmission in a second rotation speed range.

The control clutch 2 may for example be configured as a controllable friction clutch, in particular a multiplate clutch, or in a particularly preferred embodiment as shown in FIG. 2, as a selectable controllable hydrodynamic clutch 16. FIG. 2 illustrates an embodiment corresponding to FIG. 1a, so the same reference signs are used for the same elements, but the control clutch 20 is configured as a hydrodynamic clutch 16.

The control clutch 20 comprises a first clutch part K1 which is connected at least indirectly to the input E. In FIGS. 1a to 6, the connection takes place via the superposition gear mechanism 3, in particular by the direct connection to the third element 5 of the superposition gear mechanism 3. The clutch part K1 cooperates at least indirectly, preferably directly, with a second clutch part K2 which in turn is connected at least indirectly to the output A. In the configuration as a multiplate clutch, the clutch parts K1 and K2 are formed by clutch plates. If the control clutch 20 is configured as a controllable hydrodynamic clutch 16, the first clutch part K1 is formed by an impeller PK and the second clutch part K2 by the turbine wheel TK, wherein the impeller PK is connected at least indirectly to the input E, in particular to an element which is connected thereto, while the turbine wheel TK is connected at least indirectly, preferably directly, to the output A of the power transmission device 1. In a particularly advantageous embodiment, the impeller PK is connected to the third element of the planetary gear mechanism 4, in particular to a component in the connection between the third element and output A, here directly to the ring gear 5.

In order to be able to transmit the power via the reverse torque converter 16 in the second rotation speed range, bypassing the control clutch, the control clutch 20 is switchable or preferably bridged.

With regard to the structure and design of the control clutch as a hydrodynamic controllable clutch 16, there is a multiplicity of possibilities. This may be a clutch with a fill level control, or a clutch with a scoop tube.

FIGS. 1a to 5 illustrate an embodiment with coaxial arrangement of reverse torque converter 2, superposition gear mechanism 3 and control clutch 20. The input E and output A are arranged eccentrically. In a particularly advantageous embodiment, viewed in the axial direction, the control clutch 20 is arranged on the side of the superposition gear mechanism 3 facing away from the reverse torque converter 2. By coupling the first clutch part K1 to the superposition gear mechanism 3, in particular its output, in the operating range of the control clutch 20, this is driven with a higher rotation speed than in the arrangement with direct coupling to the input E, whereby the control clutch may be dimensioned smaller.

In order to be able to drive the output A via the hydrodynamic clutch 16, it is furthermore necessary to support the element of the planetary gear mechanism 4 connected to the turbine wheel T and hence the hydrodynamic power branch provided in converter mode, wherein the reverse torque converter 2 is emptied in the first rotation speed range with power transmission by the control clutch 20. For this, a device 25 is provided for supporting and/or fixing the second element of the planetary gear mechanism 4, in particular the sun wheel 6 or the connection 28 between this and the turbine wheel T. The support may take place either on a stationary component 29, in particular a housing part, or, in a further embodiment, on a component which can rotate with relative rotation speed and/or in the opposite direction, for example on the planet carrier 8 of the planetary gear mechanism 4, as depicted in FIG. 5 in a refinement of FIG. 3.

In the embodiments of FIGS. 1a and 2 to 4, according to a first embodiment the support takes place on a component 29 which is fixed relative to the housing or frame. The device 25 in FIG. 1a preferably comprises a braking device 27 with at least two brake elements 27.1 and 27.2 which can be brought into active connection with each other. The brake element 27.1 is connected rotationally fixedly to the connection between the turbine wheel T and the second element of the planetary gear mechanism 4, in particular the sun wheel 6. The second element 27.2 is fixed relative to the frame or housing. An actuating device 26 is provided for activation. The device 25 may also be configured as a hydrodynamic retarder 31, as shown in FIG. 3, or as a clutch device 32, as shown in FIG. 4.

In order to allow a direct drive between the third element, in particular the ring gear 5 of the planetary gear mechanism 4, and the output A, furthermore a direct drive device 19 is provided. This can be arranged as a separate selectable clutch between the shafts connected to the clutch parts K1 and K2, or directly as a bridging clutch between K1 and K2 or, in the design as a hydrodynamic controllable clutch 16, between the impeller PK and turbine wheel TK. In the embodiment according to FIG. 1a with controllable multiplate clutch, the function of the direct drive 19 may also be integrated in the control clutch 20. In both the latter cases, there is a possibility of coaxial arrangement of input and output, as shown for example in FIG. 6.

In the embodiments according to FIGS. 1a to 5, a separate selectable clutch is shown as a direct drive device 19 for implementing the direct drive. For this, the ring gear 5 is connected to the impeller PK via a shaft 24. The turbine wheel TK is connected to a hollow shaft 30 which, over a partial region of its extent viewed in the longitudinal direction between input E and output A, surrounds a shaft connected to the first clutch part K1 or impeller PK, and which is either directly connected to or forms the output A, or is connected thereto via a further rotation speed/torque conversion device 22.

According to FIGS. 1a to 5, the output A is arranged eccentrically to the input E. The offset is achieved via the rotation speed/torque conversion device 22. In the simplest case, this comprises two mutually engaging gear wheels 22.1, 22.2, via which an additional step up or step down can be implemented.

Alternatively, a coaxial arrangement of the output A to the hydrodynamic clutch 20 is conceivable, as shown for example in FIGS. 6 and 7. According to the embodiment in FIG. 6, the third element in the form of the ring gear 6 is formed integrally with or connected to a shaft 24. Also connected thereto is the impeller PK. The turbine wheel TK is then connected directly to or forms the output. The direct drive device 19 is provided as a lock-up clutch or bridging clutch and arranged directly between the impeller PK and turbine wheel TK.

In all embodiments, an operating medium supply system 20 is provided for filling and/or emptying the hydrodynamic components. Preferably, this is assigned in common to all hydrodynamic components, but it is also conceivable to assign this only to individual hydrodynamic components. Corresponding actuating devices at least for filling and/or emptying are assigned to each hydrodynamic component. These actuating devices are designated respectively 13 for the reverse torque converter 2, 26 for the hydrodynamic brake, and 23 for the hydrodynamic clutch 20. The device 13 for influencing the fill state or fill level comprises means for filling/emptying, preferably in the form of valve devices in the supply to and discharge from the reverse torque converter 2.

The device 23 for filling/emptying the hydrodynamic clutch 16 may either perform only the function of selection by filling and emptying, wherein then a separate actuating device 21 must be provided for influencing the transmission behavior, or may also, in concentration of function, include the actuating device 21 for influencing the transmission behavior of the control clutch 20, for example in the form of controllable valve devices and/or a so-called scoop tube in the supply to and/or discharge from the hydrodynamic clutch 16. This applies similarly to the hydrodynamic retarder 31.

To control the operating mode of the power transmission device 1, a control device 14 is provided. The control device 14 may for example be a control device assigned to the power transmission device 1. A control device is also conceivable which is assigned to the drive train 10, or to the entire system of drive train 10 and working machine 11. This device is coupled to the actuating devices for activating the individual components of the power transmission device 1. These are above all the actuating device 17 for influencing the transmission behavior of the reverse torque converter 2, the actuating device 13 for filling/emptying the reverse torque converter 2, the actuating device for activating the control clutch 20, in particular the actuating device 21 for adjusting the transmission behavior of the hydrodynamic clutch and the actuating device 23 for filling or emptying the hydrodynamic clutch 16, the actuating device 26 for operating the devices 25, and the actuating device for activating the direct drive 19. To activate the individual actuating devices, corresponding correcting variables Y13, Y17, Y19, Y21, Y23, Y26 are emitted. As an example, the following correcting variables are emitted:
Y13-0 for emptying, Y13-1 for filling the reverse torque converter 2,
Y17 is the correcting variable for activating the actuating device 17 for changing the transmission behavior of the reverse torque converter 2, for example for changing the blade position,
Y23-0 for emptying, Y23-1 for filling the hydrodynamic clutch 16,
Y20-1 for activating the control clutch 20, in particular the multiplate clutch, Y20-0 for deactivation,
Y21 for adjusting the transmission behavior of the control clutch 20 or hydrodynamic clutch 16,
Y19-1 for activating the direct drive device 19, Y19-0 for deactivation,
Y26-1 for activating the device 25 supporting and/or fixing the second element of the superposition gear mechanism 3, in particular the planetary gear mechanism 4, or the connection between the turbine wheel T and the sun wheel 6, Y26-0 for deactivation.

FIGS. 1b to 1d illustrate the operating method of the power transmission device 1, using flow diagrams. According to FIG. 1b, there are two separate operating ranges B1 and B2 which are characterized by power transmission either via the reverse torque converter 2 or via the control clutch 20 in a predefined rotation speed range. B1 stands for power transmission via the control clutch 20 and the superposition gear mechanism 3. B2 stands for power transmission mechanically/hydrodynamically via the reverse torque converter 2 and the superposition gear mechanism 3. After the start of the power transmission device, power transmission initially takes place in B1 via the control clutch 20—either purely mechanically or, in the design of the hydrodynamic clutch, mechanically/hydrodynamically. Operating mode B2 preferably takes place only on reaching the end of the control range of the control clutch 20, i.e. on reaching X20-max.

FIG. 1c illustrates, as an example using a flow diagram, the method for operating the power transmission device in operating range B1 according to FIG. 1b. On start-up of the drive train 10 and run-up of the drive machine 11, it is first checked whether the reverse torque converter 2 is emptied. If this is not the case, the device 13 is activated, here by setting a correcting variable Y13-0 which stands for emptying of the reverse torque converter 2. Then it is checked whether the second element, in particular the sun wheel 6 of the planetary gear mechanism 4, is supported. For this, the function position of the device 25 for support and/or fixing is checked. If this is not activated, the actuating device 26 is activated by output of a controlling variable Y26-1. Furthermore, the function state of the direct drive device 19 is checked. If this is activated, it is deactivated by controlling the actuating device 19 with Y19-0. The control clutch 20 is activated and the transmission behavior is set via Y21. If the control clutch is formed as a hydrodynamic clutch 16, this is filled by setting a fill signal Y23. The transmission behavior is influenced by setting a correcting variable Y21 for activating an actuating device for influencing the transmission behavior of the hydrodynamic clutch, for example a scoop tube for setting the fill level.

On reaching the end of the control range of the control clutch 20, in particular the hydrodynamic clutch 16, this is deactivated and the reverse torque converter 2 brought into operation, as shown for example in FIG. 1d. For this, the device 25 is deactivated by setting a corresponding correcting variable Y26-0, the device 19 is activated by setting Y19-1, and the reverse torque converter 2 is filled by setting an actuating signal Y13-1 for filling the reverse torque converter 2. The transmission behavior of the reverse torque converter 2 is controlled by the actuating device 17. In addition, the hydrodynamic clutch 16 may but need not necessarily be emptied. This takes place by activating the actuating device 23 by setting a corresponding emptying signal Y23-0.

The basic method is characterized by the following method steps:
running up the drive machine from a standstill with an empty hydrodynamic rotation speed/torque converter until reaching a predefined value at least indirectly characterizing the operating mode of the drive machine, in particular its nominal rotation speed,
at the same time as reaching the predefined value at least indirectly characterizing the operating mode of the drive machine, in particular the nominal rotation speed, or with a temporal offset after reaching this, engaging or activating the control clutch, in particular the hydrodynamic clutch, and supporting or fixing the second element, in particular the sun wheel of the planetary gear mechanism of the superposition gear mechanism,
controlling the transmission behavior of the control clutch over a predefined rotation speed range,
on reaching the end of the predefined rotation speed range, bridging the control clutch and deactivating the device for support and/or fixing, and filling the hydrodynamic rotation speed/torque converter, and driving the turbine wheel,
driving the third element of the planetary gear mechanism with a rotation speed which results from a superposition, defined by the planetary gear mechanism, of the rotation speed of the first element of the planetary gear mechanism connected to the drive machine, and the rotation speed of the second element of the planetary gear mechanism at least indirectly connected to the turbine wheel,
controlling the transmission behavior of the reverse torque converter.

FIG. 7 shows an alternative arrangement of the hydrodynamic clutch 16 between input E and reverse torque converter 2, viewed in the axial direction and hence on the side of the reverse torque converter 2 facing away from the superposition gear mechanism 3. In this case, the direct connection between the superposition gear mechanism 3 and output A is possible, and hence the coaxial arrangement of input E and output A with simultaneous coaxial arrangement of clutch 16, reverse torque converter 2 and superposition gear mechanism 3.

It is however also conceivable for further rotation speed/torque conversion devices 15 to be interposed between the superposition gear mechanism 3 and output A, here designated 15 and indicated by means of a dotted line.

### LIST OF REFERENCE SIGNS

1 Power transmission device
2 Reverse torque converter
3 Superposition gear mechanism
4 Planetary gear mechanism
5 Ring gear
6 Sun wheel
7 Planet wheels
8 Carrier, planet carrier
9 Drive machine, in particular electric motor
10 Drive train
11 Working machine
12 Operating medium supply/conduction system
13 Device for filling and emptying
14 Control device
15 Rotation speed/torque conversion device
16 Controllable hydrodynamic clutch
17 Actuating device for influencing the transmission behavior of the reverse torque converter
18 Hollow shaft
19 Direct drive device
20 Control clutch
21 Actuating device; scoop tube
22 Rotation speed/torque converter device
22.1, 22.2 Gear wheels
23 Actuating devices for at least filling and/or emptying the hydrodynamic clutch
24 Shaft
25 Device for supporting and/or fixing
26 Actuating device
28 Connection between turbine wheel and second element of planetary gear mechanism
29 Component fixed relative to housing
30 Hollow shaft
31 Hydrodynamic retarder
32 Clutch device
A Output, output shaft
E Input, input shaft
P Impeller (converter)
T Turbine wheel (converter)
L Guide wheel
K1 First clutch part
K2 Second clutch part
PK Impeller, clutch
TK Turbine wheel, clutch
R Rotor
S Stator
B1, B2 Operating ranges
Y13, Y17,
Y19, Y20,
Y21, Y23,
Y25 Correcting variables
X2, X19,
X25, X16 Actual values

1-14. (canceled)

15. A power transmission device, comprising:
an input for connection to a drive machine to be operated at a constant rotation speed, and at least one output for connection to a working machine to be driven at a variable rotation speed;
a hydrodynamic rotation speed and torque converter configured as a reverse torque converter with an impeller, a turbine blade wheel, and a guide wheel which form a working space to be filled with an operating medium, and said reverse torque converter being configured to be emptied;
a superposition gear mechanism with a planetary gear mechanism having a ring gear, a sun wheel, and a planet carrier with a plurality of planets forming elements of said planetary gear mechanism;
wherein said input is connected to said impeller of said reverse torque converter and to a first element of said planetary gear mechanism, said turbine wheel of said reverse torque converter is connected to a second element of said planetary gear mechanism, and a third element of said planetary gear mechanism is at least indirectly connected to, or forming, said output of said power transmission device;
a selectable control clutch for transmitting power in a first rotation speed range, with an emptied reverse torque converter, between said input and said output of the power transmission device;
a device for at least indirectly supporting and/or fixing the second element of said planetary gear mechanism in the first rotation speed range.

16. The power transmission device according to claim 15, wherein:
said input is directly connected to said impeller of said reverse torque converter and to the first element of said planetary gear mechanism;
said turbine wheel of said reverse torque converter is directly connected to the second element of said planetary gear mechanism;
the device supports a connection between said turbine wheel of said reverse torque converter and the second element of said planetary gear mechanism in the first rotation speed range.

17. The power transmission device according to claim 15, wherein said reverse torque converter, said superposition gear mechanism, and said selectable control clutch are arranged coaxially to each other.

18. The power transmission device according to claim 15, wherein:
viewed in an axial direction between said input and said output of the power transmission device, said reverse torque converter is physically arranged upstream of said superposition gear mechanism; and
said selectable control clutch is arranged on a side of said reverse torque converter facing away from said superposition gear mechanism; and
a direct drive device is assigned to said control clutch in order to bridge and create a connection between said input and said impeller of said reverse torque converter.

19. The power transmission device according to claim 15, wherein:
viewed in an axial direction between said input and said output of the power transmission device, said reverse torque converter is physically arranged upstream of said superposition gear mechanism;
said control clutch is arranged on a side of said reverse torque converter facing away from said superposition gear mechanism and an input part of said control clutch is connected to the third element of said superposition gear mechanism; and
a direct drive device is assigned to the control clutch in order to bridge and create a connection between the third element of said superposition gear mechanism and said output.

20. The power transmission device according to claim 19, wherein the output part of said control clutch is connected via a rotation speed/torque conversion device, being a spur gear train, to said output of the power transmission device.

21. The power transmission device according to claim 19, wherein said direct drive device is also formed by said control clutch in a concentration of function.

22. The power transmission device according to claim 15, wherein said control clutch is a controllable multiplate clutch.

23. The power transmission device according to claim 15, wherein said control clutch is a controllable hydrodynamic clutch being a hydrodynamic clutch with fill control.

24. The power transmission device according to claim 15, wherein said device for supporting and/or fixing the second element of said planetary gear mechanism is a braking device, wherein a rotor is directly connected to said turbine wheel of said reverse torque converter or to the connection between said turbine wheel and said second element of said planetary gear mechanism, and said stator is connected to a component which is fixed relative to the housing, or to the first element of said planetary gear mechanism.

25. The power transmission device according to claim 24, wherein said device for supporting and/or fixing the connection between the turbine wheel of the reverse torque converter and the superposition gear mechanism is a hydrodynamic retarder.

26. The power transmission device according to claim 15, wherein said device for supporting and/or fixing the second element of said planetary gear mechanism is a clutch device comprising at least two clutch parts to be brought at least indirectly into active connection with each other, wherein a first clutch part is connected directly to said turbine wheel of said reverse torque converter or to the connection between said turbine wheel and the second element of said planetary gear mechanism, and a second clutch part is connected to a component that is fixed relative to the housing or to the first element of said planetary gear mechanism.

27. The power transmission device according to claim 15, wherein said clutch device supports and/or fixes the connection between the turbine wheel of the reverse torque converter and the superposition gear mechanism.

28. The power transmission device according to claim 15, wherein said superposition gear mechanism comprises only one planetary gear mechanism, and wherein the first element of said planetary gear mechanism is formed by said carrier, the second element of said planetary gear mechanism is formed by said sun wheel, and the third element of said planetary gear mechanism is formed by said ring gear.

29. The power transmission device according to claim 15, wherein said reverse torque converter is an adjustable converter comprising adjustable blades or adjustable blade segments on at least one of the blade wheels of the impeller, the turbine wheel, and/or the guide wheel.

30. A drive train, comprising: a drive machine to be driven with a constant rotation speed and a power transmission device according to claim 15 disposed for driving a working machine with variable rotation speed.

31. A method for operating a power transmission device, the method comprising:
providing the power transmission device according to claim 15;
running up the drive machine from standstill with an empty hydrodynamic rotation speed/torque converter until reaching a predefined value at least indirectly characterizing an operating mode of the drive machine;
at the same time as reaching the predefined value at least indirectly characterizing the operating mode of the drive machine, or with a temporal offset after reaching the predefined value, engaging or activating the control clutch;
controlling a transmission behavior of the control clutch over a predefined first rotation speed range;
on reaching an end of the predefined rotation speed range, bridging the control clutch and deactivating the device for support and/or fixing, and filling the hydrodynamic rotation speed/torque converter, and driving the turbine wheel;
driving the third element of the planetary gear mechanism with a rotation speed which results from a superposition, defined by the planetary gear mechanism, of the rotation speed of the first element of the planetary gear mechanism connected to the drive machine, and the rotation speed of the second element of the planetary gear mechanism at least indirectly connected to the turbine wheel; and
controlling a transmission behavior of the reverse torque converter.

32. The method according to claim 31, wherein:
the predefined value characterizing an operating mode of the drive machine is a nominal rotation speed of the drive machine;
the hydrodynamic clutch is engaged or activated, either immediately or with a temporal offset, when the drive machine achieves the nominal rotation speed, by supporting or fixing the sun wheel of the planetary gear mechanism of the superposition gear mechanism.
